(19) United States
(12) Patent Application Publication
(10) Pub. No.: US 2025/0331630 A1
(43) Pub. Date: Oct. 30, 2025

(54) Personal Grooming Glove Device

(71) Applicant: Rodney O' Keith, Los Angeles, CA (US)

(72) Inventor: Rodney O' Keith, Los Angeles, CA (US)

(21) Appl. No.: 18/645,879

(22) Filed: Apr. 25, 2024

(51) Int. Cl. A46B 5/04; A46B 7/02; A46B 13/02; A46B 15/00; A46B 17/06; B08B 1/10; B08B 1/30; B08B 5/04

(52) U.S. Cl. CPC A46B 5/04; A46B 7/02; A46B 13/023; A46B 15/0022; A46B 15/0028; A46B 15/0038; A46B 17/06; B08B 1/10; B08B 1/30; B08B 5/04; A46B 2200/104

(57) ABSTRACT

A personal grooming glove device for brushing and styling hair includes a dominant hand glove designed to be worn on a dominant hand of a user. A brush pad may be coupled to the dominant hand glove. The brush pad has an interior space. A bristle base is positioned in the interior space. A plurality of bristles is coupled to the bristle base. A position of the bristle base is adjustable to retract the plurality of bristles. A bristle button is actuatable to adjust the position of the bristle base. A retainer is coupled to the bristle button to releasably secure the position of the bristle base. A cam base engages a cam guide to secure the position of the bristle base. A spring coupled to the button urges the bristle base upwardly to extend the plurality of bristles when the cam base releases the cam guide.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to gloves and more particularly pertains to a new glove for brushing and styling hair, and for massaging a user.

### (2) Description of Related Art Including Information Disclosed Under 37 CFR 1.97 and 1.98

The prior art relates to gloves. More specifically, the prior art relates to gloves that are used by hairstylists. Such gloves are typically disposable and designed to protect the hands of the hairstylists from dyes and other chemicals being used to treat a client's hair. However, the prior art lacks disclosure of gloves with hair brushing bristles that enable the wearer to brush and style their hair without needing to use a separate tool. Some hairstylists also offer head massage services. Thus, there is also a need for a glove that includes vibrational motors for providing such head massage services. Some services offered by hairstylists, such as braiding, can be very time consuming, which can cause soreness and muscle exhaustion in the hands of the hairstylist. A glove with vibrational massage capabilities may also be useful in such situations, to help relax the hands of the hairstylist during such rigorous services.

### BRIEF SUMMARY OF THE INVENTION

An embodiment of the disclosure meets the needs presented above by generally comprising a dominant hand glove that is configured to be worn on a dominant hand of a user. A brush pad may be coupled to the dominant hand glove. The brush pad may include an upper wall that is distal to the dominant hand glove and a peripheral edge that is coupled to and extends between the dominant hand glove and the upper wall to define an interior space. A plurality of apertures extend through the upper wall into the interior space. A plurality of bristles is outwardly extendable through the plurality of apertures of the brush pad wherein each bristle of the plurality of bristles is positioned within a respective aperture of the plurality of apertures. The plurality of bristles is movably positioned within the plurality of apertures wherein the plurality of bristles is selectively retractable into the interior space of the brush pad.

A bristle base is positioned in the interior space of the brush pad. The plurality of bristles is coupled to and extends upwardly from the bristle base. The bristle base is movably positioned within the interior space wherein a position of the bristle base relative to the upper wall of the brush pad is adjustable to selectively retract the plurality of bristles. A bristle button may be coupled to the dominant hand glove. The bristle button is coupled to the bristle base. The bristle button is actuatable to adjust the position of the bristle base. A retainer is coupled to the bristle button wherein the retainer is configured to releasably secure the position of the bristle base. The retainer includes a cam guide that is coupled to the bristle button. The cam guide is rotatably coupled to the bristle button wherein the cam guide rotates when the bristle button is actuated. A cam base is coupled to the bristle button. The cam base engages the cam guide wherein the cam base is configured to releasably secure the position of the bristle base. A spring is coupled to the bristle button distally to the bristle base. The spring is compressed when the cam base engages the cam guide. The spring urging the bristle base upwardly to extend the plurality of bristles from the interior space when the cam base releases the cam guide.

In other embodiments, a glove power source may be coupled to the dominant hand glove. A processor may be electrically coupled to the glove power source and embedded within dominant hand glove. A plurality of vibrational motors may be embedded within the dominant hand glove. The plurality of vibrational motors is dispersed across the dominant hand glove. The plurality of vibrational motors is actuatable to vibrate wherein the plurality of vibrational motors is configured to massage the user, the plurality of vibrational motors being electrically coupled to the processor wherein the processor selectively actuates the plurality of vibrational motors.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a personal grooming glove device according to an embodiment of the disclosure.

FIG. 2 is a side view of an embodiment of the disclosure.

FIG. 3 is a back view of an embodiment of the disclosure.

FIG. 4 is an isometric detailed view of an embodiment of the disclosure.

FIG. 5 is an in-use view of an embodiment of the disclosure.

FIG. 6 is a block diagram view of an embodiment of the disclosure.

FIG. 7 is a cross-sectional view of an embodiment of the disclosure.

FIG. 8 is an isometric view of an embodiment of the disclosure.

FIG. 9 is a side view of an embodiment of the disclosure.

FIG. 10 is a block diagram view of an embodiment of the disclosure.

FIG. 11 is a front view of an embodiment of the disclosure.

FIG. 12 is a block diagram of an embodiment of the disclosure.

### DETAILED DESCRIPTION OF THE INVENTION

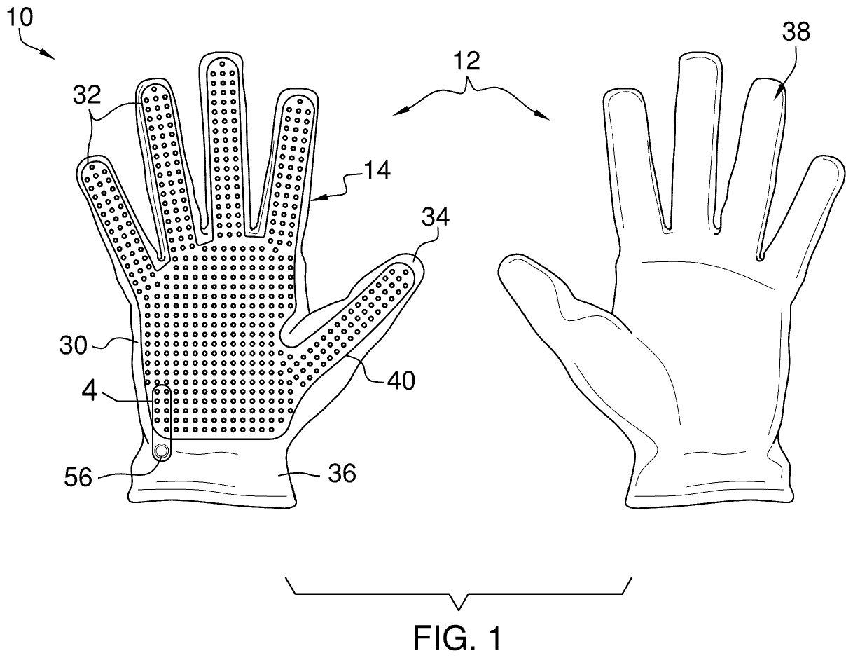

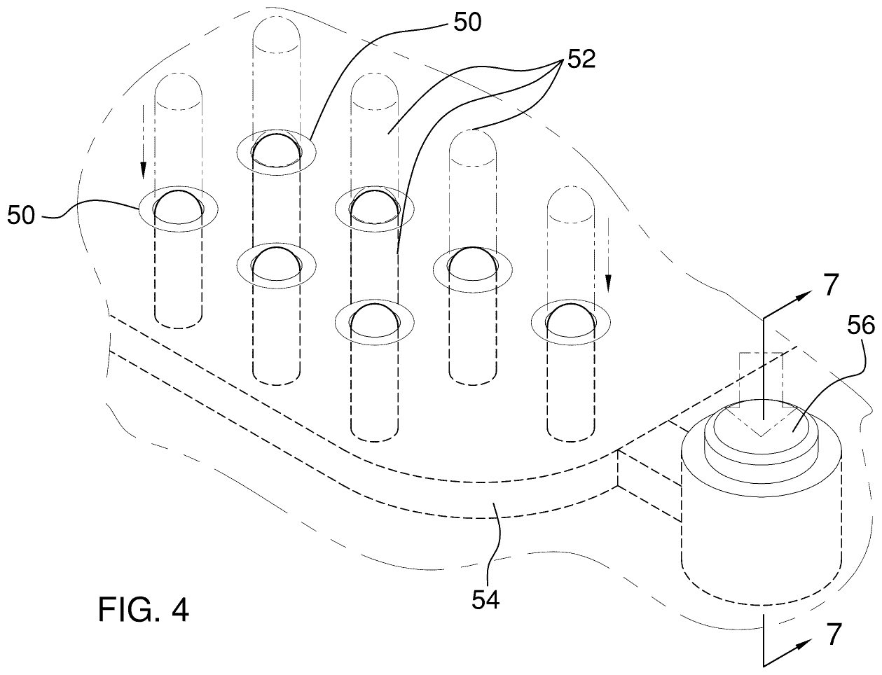

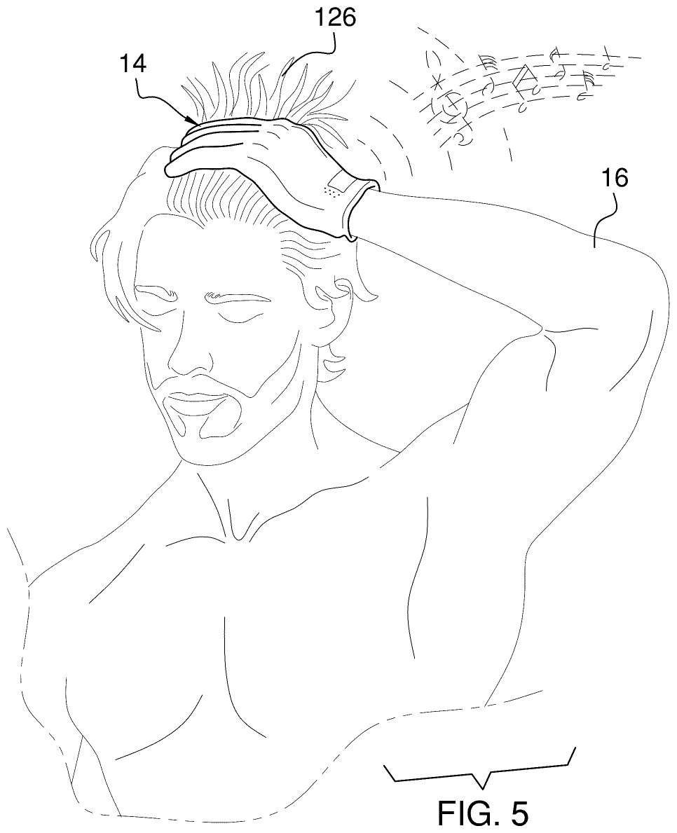

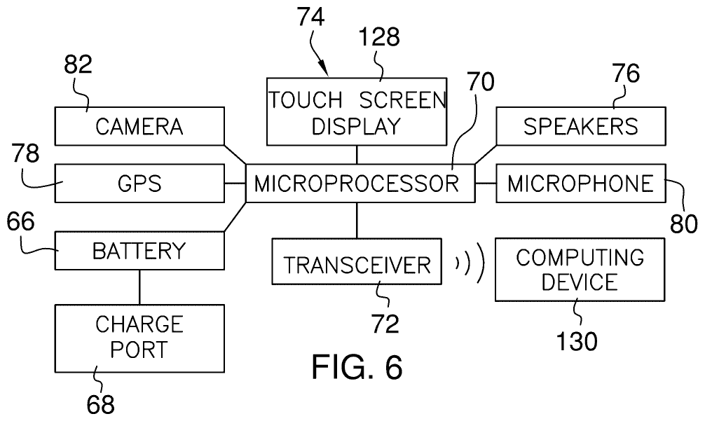

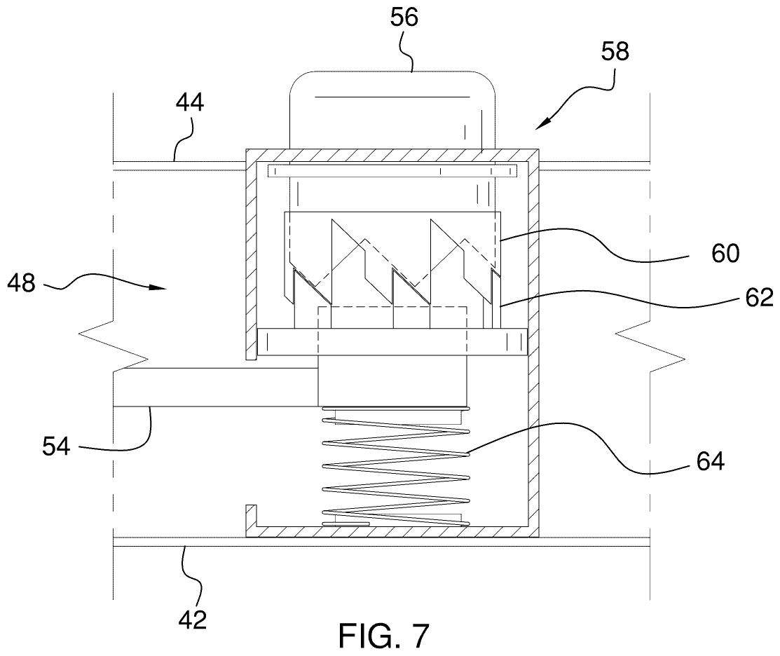

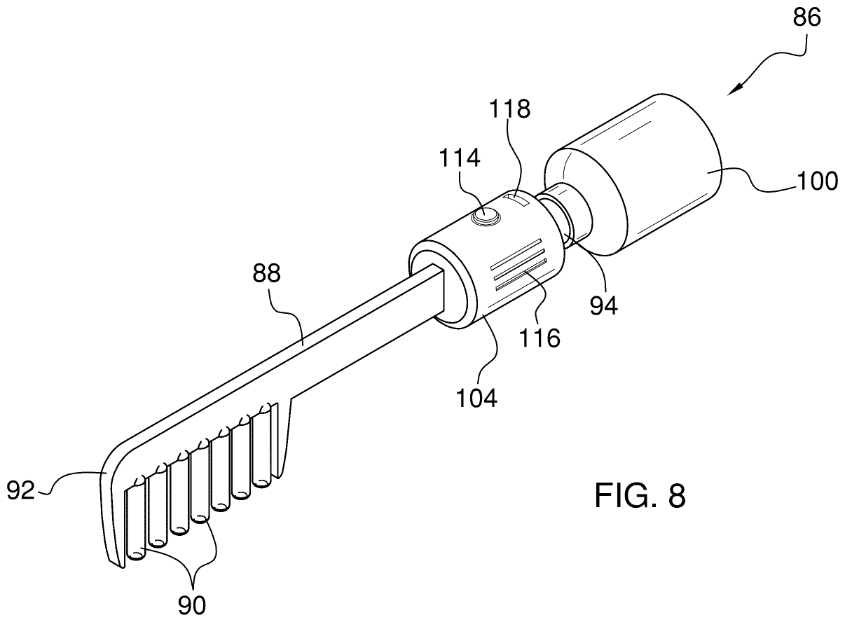

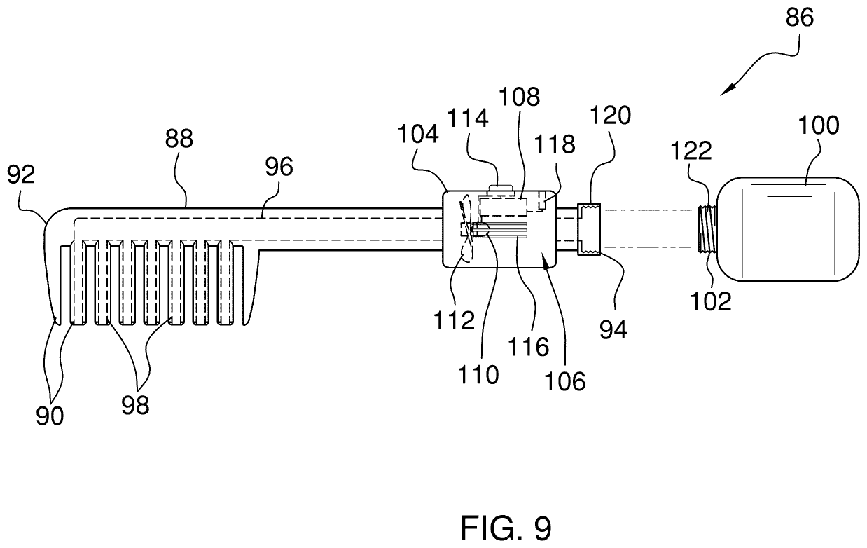

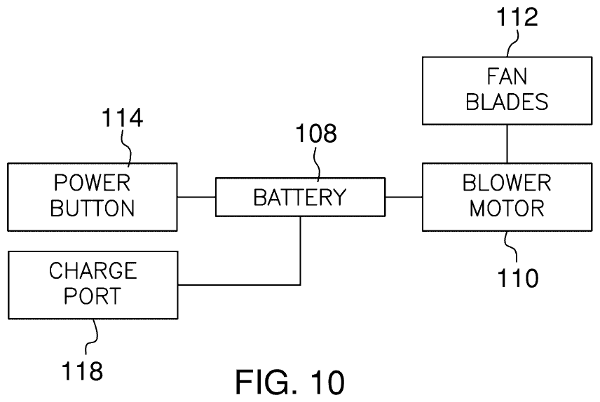

With reference now to the drawings, and in particular to FIGS. 1 through 12 thereof, a new glove embodying the principles and concepts of an embodiment of the disclosure and generally designated by the reference numeral 10 will be described.

As best illustrated in FIGS. 1 through 12, the personal grooming glove device 10 generally comprises a pair of gloves 12. The pair of gloves generally includes a dominant hand glove 14 and a non-dominant hand glove 38. The dominant hand glove 14 is configured to be worn on a dominant hand of a user 16. The dominant hand is generally a preferred one of a right hand and a left hand of the user 16 for performing fine and gross motor tasks including combing and styling hair 126. The non-dominant hand glove 38 is configured to be worn on a non-dominant hand of the user 16. For example, if the user 16 is right-handed, the dominant and glove 14 may be a right-hand glove and the non-dominant hand glove 38 may be a left-hand glove.

Each glove of the pair of gloves 12 generally includes a back panel 18 that is configured for covering a back side of the respective hand of the dominant hand and the non-dominant hand of the user 16. For example, a back panel palm portion 20 may be configured to cover the back side of a palm of the user 16. A plurality of back panel finger portions 22 may extend from the back panel palm portion 20 wherein each of the plurality of back panel finger portions 22 is configured to cover the back side of a respective finger of a plurality of fingers of the respective one of the dominant hand and the non-dominant hand of the user 16. The plurality of back panel finger portions 22 may include a back panel thumb portion 24. A back panel wrist portion 26 may extend from the back panel palm portion 20 distally to the plurality of back panel finger portions 22 wherein the back panel wrist portion 26 is configured to cover the back side of a wrist of the respective one of the dominant hand and the non-dominant hand of the user 16.

A front panel 28 may be coupled to the back panel 18 wherein the front panel 28 is configured for covering a front side of the respective one of the dominant hand and the non-dominant hand of the user 16. For example, a front panel palm portion 30 of the dominant hand glove 14 may be configured to cover the front side of the palm of the dominant hand of the user 16. The front panel palm portion 30 is generally aligned with and coupled to the back panel palm portion 20. A plurality of front panel finger portions 32 may extend from the front panel palm portion 30 wherein each of the plurality of front panel finger portions 32 is configured to cover the front side of the respective finger of the plurality of fingers of the respective hand of the dominant hand and the non-dominant hand of the user 16. The plurality of front panel finger portions 32 may include a front panel thumb portion 34. Each of the plurality of front panel finger portions 32 is generally aligned with and coupled to a respective back panel 18 finger portion of the plurality of back panel finger portions 22. A front panel wrist portion 36 may extend from the front panel palm portion 30 distally to the plurality of front panel finger portions 32 wherein the front panel wrist portion 36 is configured to cover the front side of a wrist of either the dominant hand or the non-dominant hand of the user 16. The front panel wrist portion 36 is generally aligned with and coupled to the back panel wrist portion 26.

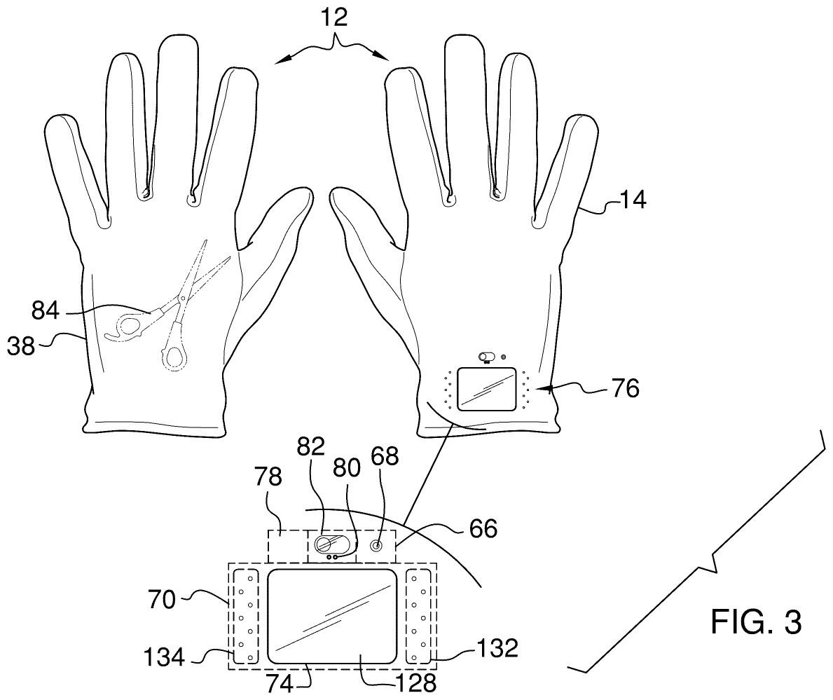

The non-dominant hand glove 38 may be designed to aesthetically coordinate with the dominant hand glove 14. For example, the non-dominant hand glove 38 may be made of materials that are the same as or visually complementary to the materials of the dominant hand glove 14. The non-dominant hand glove 38 may be the same color as the dominant hand glove 14, or may have a visually complementary color, style, or pattern compared to the dominant hand glove 14. An indicia 84 may be coupled to the non-dominant hand glove 38. For example, the indicia 84 may be printed on the non-dominant hand glove 38. The indicia 84 may include designs, images, or patterns such as the hair stylist scissors icon shown in FIG. 3. In some embodiments, the indicia 84 may also be positioned on the dominant hand glove 14.

A brush pad 40 may be coupled to the dominant hand glove 14. The brush pad 40 may be positioned on the front panel 28. For example, brush pad 40 may extend from the front panel palm portion 30 over each front panel finger portion of the plurality of front panel finger portions 32, as shown in FIG. 1. The brush pad 40 may include a resiliently deformable material wherein the brush pad 40 is configured to bend when the user 16 bends the dominant hand.

The brush pad 40 may include a lower wall 42 that is positioned against the front panel 28 of the dominant hand glove 14. An upper wall 44 may be distal to, or spaced from, the lower wall 42. The upper wall 44 may be planar. A peripheral edge 46 may be coupled to and extend between the lower wall 42 and the upper wall 44 to define an interior space 48.

A plurality of apertures 50 may extend through the upper wall 44 into the interior space 48. A plurality of bristles 52 may be outwardly extendable through the plurality of apertures 50 of the brush pad 40. For example, each bristle of the plurality of bristles 52 may be positioned within a respective aperture of the plurality of apertures 50. The plurality of bristles 52 may be movably positioned within the plurality of apertures 50 wherein the plurality of bristles 52 is selectively retractable into the interior space 48 of the brush pad 40.

A bristle base 54 may be positioned in the interior space 48 of the brush pad 40. The plurality of bristles 52 may be coupled to and extend upwardly from the bristle base 54. The bristle base 54 is movably positioned within the interior space 48 wherein a position of the bristle base 54 relative to the upper wall 44 of the brush pad 40 is adjustable to selectively retract the plurality of bristles 52 into the interior space 48 of the brush pad 40.

A bristle button 56 may be coupled to the dominant hand glove 14. The bristle button 56 is coupled to the bristle base 54. For example, the bristle base 54 may extend outwardly from the bristle button 56. The bristle button 56 is actuatable to adjust the position of the bristle base 54 within the interior space 48 of the brush pad 40. The bristle button 56 may be positioned on the front panel 28 of the dominant hand glove 14, for example on the front panel wrist portion 36, adjacent to the brush pad 40.

A retainer 58 may be coupled to the bristle button 56 wherein the retainer 58 is configured to releasably secure the position of the bristle base 54. For example, the retainer 58 may include a cam guide 60 that is coupled to the bristle button 56. The cam guide 60 may be rotatably coupled to the bristle button 56 wherein the cam guide 60 rotates when the bristle button 56 is actuated. A cam base 62 may be coupled to the bristle button 56. The cam base 62 engages the cam guide 60 wherein the cam base 62 is configured to releasably secure the position of the bristle base 54. A spring 64 may be coupled to the bristle button 56 distally to the bristle base 54. The spring 64 may be compressed when the cam base 62 engages the cam guide 60. The spring 64 may urge the bristle base 54 upwardly to extend the plurality of bristles 52 from the interior space 48 when the cam base 62 releases the cam guide 60.

A glove power source 66 may be coupled to the dominant hand glove 14. The glove power source 66 may be embedded within the dominant hand glove 14. For example, the glove power source 66 may be positioned within the back panel wrist portion 26 of the back panel 18. The glove power source 66 may be a rechargeable battery.

A glove charging port 68 may be electrically coupled to the glove power source 66. The glove charging port 68 may be positioned adjacent to the glove power source 66. For example, the glove charging port 68 may be inset into the back panel wrist portion 26 of the back panel 18, and the glove charging port 68 may be exposed within the back panel wrist portion 26 of the back panel 18.

A processor 70 may be electrically coupled to the glove power source 66. The processor 70 may be positioned on the dominant hand glove 14. For example, the processor 70 may be embedded within the back panel wrist portion 26 of the back panel 18 of the dominant hand glove 14.

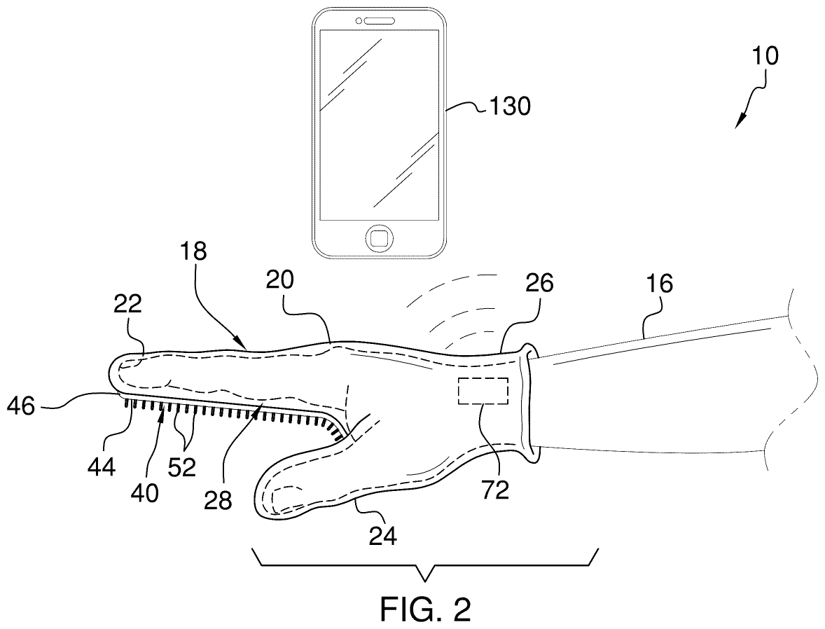

A transceiver 72 may be electrically coupled to the processor 70. The transceiver 72 may be embedded within the dominant hand glove 14. For example, the transceiver 72 may be positioned within the back panel wrist portion 26 of the back panel 18. The transceiver 72 is generally configured to wirelessly communicate with a personal computing device 130. For example, the transceiver 72 may comprise a short-range wireless transceiver or a personal area network transceiver, such as a BLUETOOTH® transceiver. The transceiver 72 facilitates wireless communication with the personal computing device 130, which may comprise a cell phone, as shown in FIG. 2.

A display panel 74 may be electrically coupled to the processor 70. The display panel 74 may be coupled to the dominant hand glove 14. For example, the display panel 74 may be positioned on the back panel wrist portion 26 of the back panel 18. As shown in FIG. 3, the display panel 74 may be positioned proximate to the glove charging port 68. The display panel 74 may include a touch screen 128 wherein the display panel 74 is configured to facilitate the user 16 in manipulating applications that are stored on the personal computing device 130. For example, the display panel 74 may be configured to display one or more of a time of day, a stopwatch, a timer, an audio file, a contact information, a global positioning system navigation display, a photograph, or a video. Embodiments of the display panel 74 may facilitate the dominant hand glove 14 to function similarly to a smart watch. In embodiments where the display panel 74 is a touch screen 128, the display panel 74 may facilitate the user 16 in interacting with applications is stored on the personal computing device 130, for example to change the audio file that is being played, to manipulate the timer, or to make a phone call with the contact information.

A speaker 76 may be electrically coupled to the glove power source 66. The processor 70 is configured to play an audio file that is accessed by the personal computing device 130 audibly through the speaker 76. The speaker 76 may be positioned on the back panel wrist portion 26 of the back panel 18 of the dominant hand glove 14, proximate to the display panel 74. For example, the speaker 76 may include a right speaker 132 that is positioned adjacent to a first side of the display panel 74 and a left speaker 134 that is positioned adjacent to a second side of the display panel 74.

A global positioning system chip 78 may be electrically coupled to the processor 70. The global positioning system chip 78 may be embedded within the dominant hand glove 14. For example, the global positioning system chip 78 may be positioned within the back panel wrist portion 26 of the back panel 18. The global positioning system chip 78 is actuatable to identify a geographic location of the dominant hand glove 14. The transceiver 72 is configured to wirelessly communicate the geographic location to the personal computing device 130.

A microphone 80 may be electrically coupled to the processor 70. The microphone 80 may be configured to facilitate the user 16 in manipulating applications that are stored on the personal computing device 130 using voice commands. The microphone 80 may be positioned on the dominant hand glove 14. For example, the microphone 80 may be positioned on the back panel wrist portion 26 of the back panel 18 of the dominant hand glove 14 adjacent to the display panel 74.

A camera 82 may be electrically coupled to the processor 70. The camera 82 may be actuatable to capture one or both of a photograph and a video file. The transceiver 72 may be configured to wirelessly transmit the photograph and the video file to the personal computing device 130. The processor 70 may be configured to display the photograph and the video file on the display panel 74. The processor 70 may also be configured to actuate the camera 82 when the microphone 80 detects a camera voice command from the user 16. For example, the camera voice command may include voice commands such as “glove camera, take a photograph” or “glove camera, record a video.” The processor 70 may be further configured to actuate the camera 82 when the user 16 manipulates the touch screen 128 of the display panel 74. In embodiments, the camera 82 may be coupled to the dominant hand glove 14. For example, the camera 82 may be positioned on the back panel wrist portion 26 of the back panel 18 of the dominant hand glove 14. As shown in FIG. 3, the camera 82 may be positioned adjacent to the microphone 80 and the display panel 74.

Embodiments may further include a comb 86. The comb 86 generally includes a shaft 88 that is coupled to a row of teeth 90. The shaft 88 may have a tooth end 92 and a handle end 94. The row of teeth 90 generally extend downwardly from the shaft 88. The row of teeth 90 is generally positioned on the tooth end 92. Each tooth of the row of teeth 90 may be perpendicular to the shaft 88. Each tooth of the row of teeth 90 has a size that is complementary to a size of the plurality of bristles 52 wherein the comb 86 is configured to facilitate the user 16 in removing debris from between the plurality of bristles 52 on the brush pad 40.

For example, a shaft chamber 96 may extend through the shaft 88. A plurality of tooth chambers 98 may extend through the row of teeth 90. Each tooth chamber of the plurality of tooth chambers 98 is generally positioned within a respective tooth of the row of teeth 90. The plurality of tooth chambers 98 is fluidly coupled to the shaft chamber 96.

A container 100 may be removably couplable to the handle end 94 of the shaft 88. The container 100 is fluidly coupled to the shaft chamber 96 when the container 100 is coupled to the shaft 88. The container 100 may include a mouth 102 with a radius that is less than a radius of the handle end 94 of the shaft 88 wherein the mouth 102 is positionable within the handle end 94 to couple the container 100 to the shaft 88. The mouth 102 is generally open.

A handle casing 104 may be coupled to the shaft 88. The handle casing 104 may be positioned proximate to the handle end 94. The handle casing 104 has an inner area 106. The inner area 106 is fluidly coupled to the shaft chamber 96.

A comb power source 108 may be positioned within the inner area 106. The comb power source 108 may be a rechargeable battery. A comb charging port 118 may be electrically coupled to the comb power source 108. The comb charging port 118 may be positioned adjacent to the comb power source 108. For example, the comb charging port 118 may be inset into and exposed within the handle casing 104.

A comb motor 110 may be positioned in the inner area 106. The comb motor 110 is electrically coupled to the comb power source 108. The comb motor 110 may be a rotational motor.

A plurality of fan blades 112 may be rotatably coupled to the comb motor 110. The comb motor 110 is actuatable to rotate the plurality of fan blades 112. Rotation of the plurality of fan blades 112 creates a suction force into the plurality of tooth chambers 98, through the shaft chamber 96, and outwardly into the container 100. The suction force is configured to remove the debris from between the plurality of bristles 52 on the brush pad 40.

A comb power button 114 may be electrically coupled to the comb power source 108. The comb power button 114 is actuatable to actuate the comb motor 110. The comb power button 114 may be positioned on the handle casing 104.

A vent 116 may extend through the handle casing 104 into the inner area 106. The vent 116 is configured to facilitate airflow through the inner area 106.

A shaft threading 120 may extend from the handle end 94 of the shaft 88 toward the tooth end 92. A container threading 122 may extend from the mouth 102 of the container 100. The container threading 122 is complementary to the shaft threading 120 wherein the container 100 is threadably couplable to the shaft 88.

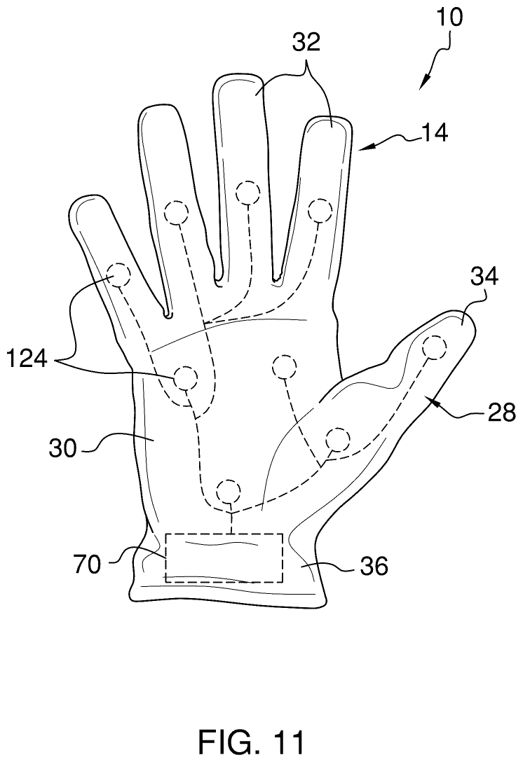

In other embodiments, a plurality of vibrational motors 124 may be embedded within a glove of the pair of gloves 12. For example, the plurality of vibrational motors 124 may be positioned on the dominant hand glove 14, as shown in FIG. 11. In other embodiments, the plurality of vibrational motors 124 may be positioned on the non-dominant hand glove 38. The plurality of vibrational motors 124 is generally dispersed across the front panel 28 wherein one or more of the plurality of vibrational motors 124 is positioned on the front panel palm portion 30 and on each front panel finger portion of the plurality of front panel finger portions 32.

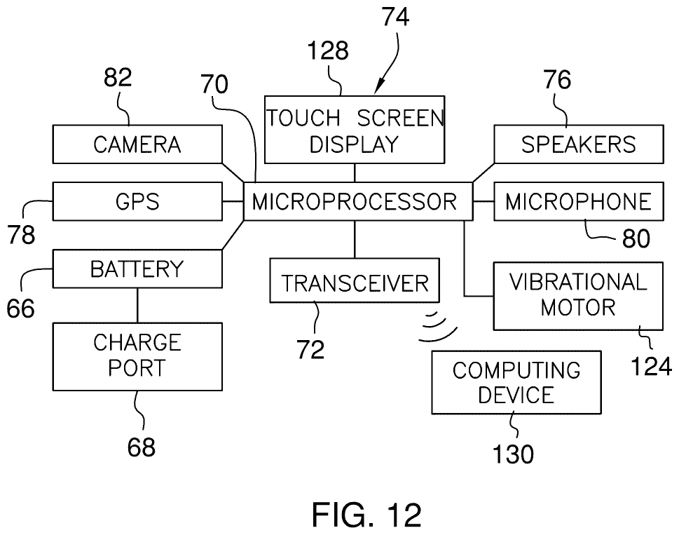

The plurality of vibrational motors 124 is actuatable to vibrate wherein the plurality of vibrational motors 124 is configured to massage the user 16. The plurality of vibrational motors 124 may be electrically coupled to the processor 70 wherein the processor 70 selectively actuates the plurality of vibrational motors 124. For example, the user 16 may actuate the plurality of vibrational motors 124 using the personal computing device 130 or the touch screen 128 of the display panel 74. FIGS. 11 and 12 depict examples of such embodiments.

In use, the user 16 can wear one or both gloves of the pair of gloves 12. Specifically, the user 16 can wear the dominant hand glove 14 on their dominant hand and the non-dominant hand glove 38 on their non-dominant hand. In embodiments according to FIGS. 1-7, the user 16 can press the bristle button 56 to extend the plurality of bristles 52 outwardly from the interior space 48 of the brush pad 40 through the plurality of apertures 50. The user 16 can then brush their hair 126, or the hair 126 of another individual, using the plurality of bristles 52. When the user 16 does not need to use the plurality of bristles 52, for example because the user 16 is braiding the hair 126, the user 16 can press the bristle button 56 to retract the plurality of bristles 52 into the interior space 48 of the brush pad 40.

The user 16 may use a voice command or the touch screen 128 on the display panel 74 to play music or other audio files through the speaker 76 on the dominant hand glove 14. For example, the processor 70 may be configured to play the audio files when the microphone 80 registers the voice command. The user 16 may also access other applications stored on the personal computing device 130 using the dominant hand glove 14, such as identifying the geographic location of the dominant hand glove 14 using the global positioning system chip 78 and a mapping application. In some embodiments, the transceiver 72 may also facilitate the user 16 in making phone calls from the personal computing device 130. Thus, the personal grooming glove device 10 can provide entertainment and other information for the user 16 as the user 16 is grooming themselves, or another individual, with the dominant hand glove 14.

The comb 86 can be used to clean the brush pad 40, for example by removing debris from between the plurality of bristles 52. The suction force from the rotation of the plurality of fan blades 112 can pull the debris from the brush pad 40 and the plurality of bristles 52 into the container 100 for collection and subsequent disposal.

In embodiments according to FIGS. 11 and 12, the dominant hand glove 14 may include the plurality of vibrational motors 124, instead of the brush pad 40 and the plurality of bristles 52. Such embodiments may be used to provide a vibrational massage for the user 16, or for another individual. Like the embodiments shown in FIGS. 1-7, the user 16 may play audio files or otherwise interact with the personal computing device 130 using the dominant hand glove 14. In other embodiments, the plurality of vibrational motors 124 may be embedded in the non-dominant hand glove 38, enabling the user 16 to brush and style the hair 126 with the dominant hand glove 14 while providing a massage with the non-dominant hand glove 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hairstyling assembly comprising:
a dominant hand glove being configured to be worn on a dominant hand of a user;
a brush pad being coupled to the dominant hand glove, the brush pad including:
an upper wall being distal to the dominant hand glove;
a peripheral edge being coupled to and extending between the dominant hand glove and the upper wall to define an interior space;
a plurality of apertures extending through the upper wall into the interior space;
a plurality of bristles being outwardly extendable through the plurality of apertures of the brush pad wherein each bristle of the plurality of bristles is positioned within a respective aperture of the plurality of apertures, the plurality of bristles being movably positioned within the plurality of apertures wherein the plurality of bristles is selectively retractable into the interior space of the brush pad;
a bristle base being positioned in the interior space of the brush pad, the plurality of bristles being coupled to and extending upwardly from the bristle base, the bristle base being movably positioned within the interior space wherein a position of the bristle base relative to the upper wall of the brush pad is adjustable to selectively retract the plurality of bristles;
a bristle button being coupled to the dominant hand glove, the bristle button being coupled to the bristle base, the bristle button being actuatable to adjust the position of the bristle base;
a retainer being coupled to the bristle button wherein the retainer is configured to releasably secure the position of the bristle base, the retainer including:
a cam guide being coupled to the bristle button, the cam guide being rotatably coupled to the bristle button wherein the cam guide rotates when the bristle button is actuated;
a cam base being coupled to the bristle button, the cam base engaging the cam guide wherein the cam base is configured to releasably secure the position of the bristle base; and
a spring being coupled to the bristle button distally to the bristle base, the spring being compressed when the cam base engages the cam guide, the spring urging the bristle base upwardly to extend the plurality of bristles from the interior space when the cam base releases the cam guide.

2. The hairstyling assembly of claim 1, further comprising a glove power source being coupled to the dominant hand glove.

3. The hairstyling assembly of claim 2, further comprising:
a processor being electrically coupled to the glove power source, the processor being embedded within the dominant hand glove; and
a transceiver being electrically coupled to the processor, the transceiver being configured to wirelessly communicate with a personal computing device.

4. The hairstyling assembly of claim 3, further comprising a display panel being electrically coupled to the processor, the display panel being coupled to the dominant hand glove.

5. The hairstyling assembly of claim 4, the display panel further comprising a touch screen wherein the display panel is configured to facilitate the user in manipulating applications being stored on the personal computing device.

6. The hairstyling assembly of claim 3, further comprising a speaker being electrically coupled to the processor, the processor being configured to audibly play an audio file being accessed by the personal computing device through the speaker.

7. The hairstyling assembly of claim 3, further comprising a global positioning system chip being electrically coupled to the processor, the global positioning system chip being embedded within the dominant hand glove, the global positioning system chip being actuatable to identify a geographic location of the dominant hand glove, the transceiver being configured to wirelessly communicate the geographic location to the personal computing device.

8. The hairstyling assembly of claim 3, further comprising a microphone being electrically coupled to the processor, the microphone being configured to facilitate the user in manipulating applications being stored on the personal computing device using voice commands.

9. The hairstyling assembly of claim 3, further comprising a camera being electrically coupled to the processor, the camera being actuatable to capture a photograph, the transceiver being configured to wirelessly transmit the photograph to the personal computing device.

10. The hairstyling assembly of claim 1, further comprising a comb having a shaft being coupled to a row of teeth, the shaft having a tooth end and a handle end, the row of teeth extending downwardly from the shaft, the row of teeth being positioned on the tooth end, each tooth of the row of teeth being perpendicular to the shaft, each tooth of the row of teeth having a size being complementary to a size of the plurality of bristles wherein the comb is configured to facilitate the user in removing debris from between the plurality of bristles on the brush pad.

11. The hairstyling assembly of claim 10, the comb further comprising:
a shaft chamber extending through the shaft;
a plurality of tooth chambers extending through the row of teeth, each tooth chamber of the plurality of tooth chambers being positioned within a respective tooth of the row of teeth, the plurality of tooth chambers being fluidly coupled to the shaft chamber;
a container being removably couplable to the handle end of the shaft, the container being fluidly coupled to the shaft chamber when the container is coupled to the shaft;
a handle casing being coupled to the shaft proximate to the handle end, the handle casing having an inner area, the inner area being fluidly coupled to the shaft chamber;
a comb power source being positioned within the inner area;
a comb motor being positioned in the inner area, the comb motor being electrically coupled to the comb power source;
a plurality of fan blades being rotatably coupled to the comb motor, the comb motor being actuatable to rotate the plurality of fan blades wherein rotation of the plurality of fan blades creates a suction force into the plurality of tooth chambers, through the shaft chamber, and outwardly into the container, the suction force being configured to remove the debris from between the plurality of bristles on the brush pad;
a comb power button being electrically coupled to the comb power source, the comb power button being actuatable to actuate the comb motor; and
a vent extending through the handle casing into the inner area wherein the vent is configured to facilitate airflow through the inner area.

12. The hairstyling assembly of claim 11, the comb further comprising a comb charging port being electrically coupled to the comb power source.

13. The hairstyling assembly of claim 11, the container further comprising a mouth having a radius being less than a radius of the handle end of the shaft wherein the mouth is positionable within the handle end to couple the container to the shaft.

14. The hairstyling assembly of claim 13, further comprising:
a shaft threading extending from the handle end of the shaft; and
a container threading extending from the mouth of the container, the container threading being complementary to the shaft threading wherein the container is threadably couplable to the shaft.

15. A hairstyling assembly comprising:
a pair of gloves including a dominant hand glove being configured to be worn on a dominant hand of a user and a non-dominant hand glove being configured to be worn on a non-dominant hand of the user, each glove of the pair of gloves including:
a back panel being configured for covering a back side of a respective one of the dominant hand and the non-dominant hand of the user, the back panel including:
a back panel palm portion being configured to cover the back side of a palm of the respective one of the dominant hand and the non-dominant hand of the user;
a plurality of back panel finger portions extending from the back panel palm portion wherein each of the plurality of back panel finger portions is configured to cover the back side of a respective finger of a plurality of fingers of the respective one of the dominant hand and the non-dominant hand of the user, the plurality of back panel finger portions including a back panel thumb portion;
a front panel being coupled to the back panel wherein the front panel is configured for covering a front side of the respective one of the dominant hand and the non-dominant hand of the user, the front panel including:
a front panel palm portion being configured to cover the front side of the palm of the respective one of the dominant hand and the non-dominant hand of the user, the front panel palm portion being aligned with the back panel palm portion;
a plurality of front panel finger portions extending from the front panel palm portion wherein each of the plurality of front panel finger portions is configured to cover the front side of the respective finger of the plurality of fingers of the respective one of the dominant hand and the non-dominant of the user, each of the plurality of front panel finger portions being aligned with a respective back panel finger portion of the plurality of back panel finger portions;
a glove power source being coupled to a glove of the pair of gloves;
a processor being electrically coupled to the glove power source, the processor being embedded within the glove of the pair of gloves; and
a plurality of vibrational motors being embedded within the glove of the pair of gloves, the plurality of vibrational motors being dispersed across the front panel wherein one or more of the plurality of vibrational motors is positioned on the front panel palm portion and on each front panel finger portion of the plurality of front panel finger portions, the plurality of vibrational motors being actuatable to vibrate wherein the plurality of vibrational motors is configured to massage the user, the plurality of vibrational motors being electrically coupled to the processor wherein the processor selectively actuates the plurality of vibrational motors.

16. The hairstyling assembly of claim 15, further comprising a transceiver being electrically coupled to the processor, the transceiver being configured to wirelessly communicate with a personal computing device.

17. The hairstyling assembly of claim 16, further comprising:
a display panel being electrically coupled to the processor wherein the display panel is configured to facilitate the user in manipulating applications being stored on the personal computing device, the display panel being coupled to the glove of the pair of gloves;
a camera being electrically coupled to the processor, the camera being actuatable to capture a photograph, the transceiver being configured to wirelessly transmit the photograph to the personal computing device;
a speaker being electrically coupled to the processor, the processor being configured to audibly play an audio file being accessed by the personal computing device through the speaker; and
a microphone being electrically coupled to the processor, the microphone being configured to facilitate the user in manipulating applications being stored on the personal computing device using voice commands.

18. The hairstyling assembly of claim 16, further comprising a global positioning system chip being electrically coupled to the processor, the global positioning system chip being embedded within the dominant hand glove, the global positioning system chip being actuatable to identify a geographic location of the dominant hand glove, the transceiver being configured to wirelessly communicate the geographic location to the personal computing device.

19. A hairstyling assembly comprising:
a pair of gloves including:
a dominant hand glove being configured to be worn on a dominant hand of a user, the dominant hand glove including:
a back panel being configured for covering a back side of the dominant hand of the user, the back panel including:
a back panel palm portion being configured to cover the back side of a palm of the dominant hand of the user;
a plurality of back panel finger portions extending from the back panel palm portion wherein each of the plurality of back panel finger portions is configured to cover the back side of a respective finger of a plurality of fingers of the dominant hand of the user, the plurality of back panel finger portions including a back panel thumb portion;
a back panel wrist portion extending from the back panel palm portion distally to the plurality of back panel finger portions wherein the back panel wrist portion is configured to cover the back side of a wrist of the dominant hand of the user;
a front panel being coupled to the back panel wherein the front panel is configured for covering a front side of the dominant hand of the user, the front panel including:
a front panel palm portion being configured to cover the front side of the palm of the dominant hand of the user, the front panel palm portion being aligned with the back panel palm portion;
a plurality of front panel finger portions extending from the front panel palm portion wherein each of the plurality of front panel finger portions is configured to cover the front side of the respective finger of the plurality of fingers of the dominant hand of the user, the plurality of front panel finger portions including a front panel thumb portion, each of the plurality of front panel finger portions being aligned with a respective back panel finger portion of the plurality of back panel finger portions;
a front panel wrist portion extending from the front panel palm portion distally to the plurality of front panel finger portions wherein the front panel wrist portion is configured to cover the front side of the wrist of the dominant hand of the user, the front panel wrist portion being aligned with the back panel wrist portion;
a non-dominant hand glove being configured to be worn on a non-dominant hand of the user, the non-dominant hand glove including:
an indicia being coupled to the non-dominant hand glove, the indicia being printed on the non-dominant hand glove;
a brush pad being coupled to the dominant hand glove, the brush pad being positioned on the front panel, the brush pad including:
a lower wall being positioned against the front panel of the dominant hand glove;
an upper wall being distal to the lower wall, the upper wall being planar;
a peripheral edge being coupled to and extending between the lower wall and the upper wall to define an interior space;
a plurality of apertures extending through the upper wall into the interior space;
a plurality of bristles being outwardly extendable through the plurality of apertures of the brush pad wherein each bristle of the plurality of bristles is positioned within a respective aperture of the plurality of apertures, the plurality of bristles being movably positioned within the plurality of apertures wherein the plurality of bristles is selectively retractable into the interior space of the brush pad;
a bristle base being positioned in the interior space of the brush pad, the plurality of bristles being coupled to and extending upwardly from the bristle base, the bristle base being movably positioned within the interior space wherein a position of the bristle base relative to the upper wall of the brush pad is adjustable to selectively retract the plurality of bristles;
a bristle button being coupled to the dominant hand glove, the bristle button being coupled to the bristle base wherein the bristle base extends outwardly from the bristle button, the bristle button being actuatable to adjust the position of the bristle base, the bristle button being positioned on the front panel of the dominant hand glove adjacent to the brush pad;
a retainer being coupled to the bristle button wherein the retainer is configured to releasably secure the position of the bristle base, the retainer including:
a cam guide being coupled to the bristle button, the cam guide being rotatably coupled to the bristle button wherein the cam guide rotates when the bristle button is actuated;
a cam base being coupled to the bristle button, the cam base engaging the cam guide wherein the cam base is configured to releasably secure the position of the bristle base;
a spring being coupled to the bristle button distally to the bristle base, the spring being compressed when the cam base engages the cam guide, the spring urging the bristle base upwardly to extend the plurality of bristles from the interior space when the cam base releases the cam guide;
a glove power source being coupled to the dominant hand glove, the glove power source being embedded within the back panel wrist portion of the back panel, the glove power source being a rechargeable battery;
a glove charging port being electrically coupled to the glove power source, the glove charging port being inset into the back panel wrist portion of the back panel, the glove charging port being exposed within the back panel wrist portion of the back panel;
a processor being electrically coupled to the glove power source, the processor being embedded within the back panel wrist portion of the back panel of the dominant hand glove;
a transceiver being electrically coupled to the processor, the transceiver being embedded within the dominant hand glove, the transceiver being positioned within the back panel wrist portion of the back panel, the transceiver being configured to wirelessly communicate with a personal computing device;
a display panel being electrically coupled to the processor, the display panel being coupled to the dominant hand glove, the display panel being positioned on the back panel wrist portion of the back panel proximate to the glove charging port, the display panel including a touch screen wherein the display panel is configured to facilitate the user in manipulating applications being stored on the personal computing device;
a speaker being electrically coupled to the processor, the processor being configured to audibly play an audio file being accessed by the personal computing device through the speaker, the speaker being positioned on the back panel wrist portion of the back panel of the dominant hand glove, the speaker including:
a right speaker being positioned adjacent to a first side of the display panel;
a left speaker being positioned adjacent to a second side of the display panel;
a global positioning system chip being electrically coupled to the processor, the global positioning system chip being embedded within the dominant hand glove, the global positioning system chip being positioned within the back panel wrist portion of the back panel, the global positioning system chip being actuatable to identify a geographic location of the dominant hand glove, the transceiver being configured to wirelessly communicate the geographic location to the personal computing device;
a microphone being electrically coupled to the processor, the microphone being configured to facilitate the user in manipulating applications being stored on the personal computing device using voice commands, the microphone being positioned on the back panel wrist portion of the back panel of the dominant hand glove adjacent to the display panel;
a camera being electrically coupled to the processor, the camera being actuatable to capture a photograph, the transceiver being configured to wirelessly transmit the photograph to the personal computing device, the processor being configured to actuate the camera when the microphone detects a camera voice command from the user, the camera being positioned on the back panel wrist portion of the back panel of the dominant hand glove adjacent to the microphone;
a comb having a shaft being coupled to a row of teeth, the shaft having a tooth end and a handle end, the row of teeth extending downwardly from the shaft, the row of teeth being positioned on the tooth end, each tooth of the row of teeth being perpendicular to the shaft, each tooth of the row of teeth having a size being complementary to a size of the plurality of bristles wherein the comb is configured to facilitate the user in removing debris from between the plurality of bristles on the brush pad, the comb further including:
a shaft chamber extending through the shaft;
a plurality of tooth chambers extending through the row of teeth, each tooth chamber of the plurality of tooth chambers being positioned within a respective tooth of the row of teeth, the plurality of tooth chambers being fluidly coupled to the shaft chamber;
a container being removably couplable to the handle end of the shaft, the container being fluidly coupled to the shaft chamber when the container is coupled to the shaft, the container including:
a mouth having a radius being less than a radius of the handle end of the shaft wherein the mouth is positionable within the handle end to couple the container to the shaft, the mouth being open;
a handle casing being coupled to the shaft proximate to the handle end, the handle casing having an inner area, the inner area being fluidly coupled to the shaft chamber;
a comb power source being positioned within the inner area, the comb power source being a rechargeable battery;
a comb motor being positioned in the inner area, the comb motor being electrically coupled to the comb power source;
a plurality of fan blades being rotatably coupled to the comb motor, the comb motor being actuatable to rotate the plurality of fan blades wherein rotation of the plurality of fan blades creates a suction force into the plurality of tooth chambers, through the shaft chamber, and outwardly into the container, the suction force being configured to remove the debris from between the plurality of bristles on the brush pad;
a comb power button being electrically coupled to the comb power source, the comb power button being actuatable to actuate the comb motor, the comb power button being positioned on the handle casing;
a vent extending through the handle casing into the inner area wherein the vent is configured to facilitate airflow through the inner area;
a comb charging port being electrically coupled to the comb power source, the comb charging port being inset into the handle casing, the comb charging port being exposed within the handle casing;
a shaft threading extending from the handle end of the shaft; and
a container threading extending from the mouth of the container, the container threading being complementary to the shaft threading wherein the container is threadably couplable to the shaft.
